(19) United States
(12) Patent Application Publication
(10) Pub. No.: US 2008/0184895 A1
(43) Pub. Date: Aug. 7, 2008

(54) Coffee Maker

(76) Inventor: Ting-Chen Hsu, Tainan City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/670,036

(22) Filed: Feb. 1, 2007

(51) Int. Cl. A47J 31/44; A47J 31/16; A47J 31/40

(52) U.S. Cl. 99/290; 99/293

(57) ABSTRACT

A coffee maker allowing simultaneous brewing and frothing includes a steam boiler, a brewing unit, and a frothing unit. Steam from the steam boiler is respectively introduced into both the brewing unit and the frothing unit. The brewing unit contains a disk to accommodate a coffee pack. The frothing unit disposed on top of the steam boiler includes an inlet tube to introduce steam, a duct connecting to an inlet tube and an outlet, a suction tube connecting to one side of the duct close to the outlet. The suction tube has an opening located inside the frothing unit. A replaceable disk is movably inserted into a chamber of the brewing unit and is made in a size corresponding to that of a coffee pack.

### BACKGROUND OF THE INVENTION

(a) Field of the Invention

The present invention relates to a coffee make, and more particularly, to one provided with a frothing unit containing a cylindrical cup to directly lead out steam out of a steam boiler with a duct while sucking milk into the cup to directly froth, and allowing brewing and frothing at the same time.

(b) Description of the Prior Art

Making coffee and frothing are usually done separately in coffee makers generally available in the market. A coffee maker of the prior art generally contains a steam boiler, a brewing unit, and a frothing unit. The steam boiler produces steam to be introduced into the brewing unit and the frothing unit. The brewing unit includes a bowl to contain coffee. The brewing and the frothing unit are arranged in parallel to each other. The frothing unit contains a steam outlet and a suction tube disposed by the side of the steam outlet. U.S. Pat. Nos. 4,800,805, 4,921,640, 5,628,239, 5,768,975, 6,644,177, and 6,810,765 respectively teach the prior art of a construction of a frothing unit.

In making coffee, the ground coffee beans are stuffed in the pot and then steam is introduced to make coffee. In frothing, a cup containing a proper amount of milk is prepared. The stream introduced causes the area by the outlet of a frothing unit to create negative pressure for sucking in the milk through the suction tube to deliver froth in the cup. The froth is then poured into coffee. Whereas, coffee and froth are respectively made and received in different containers in the prior art,

a. The brewing process tends to be complicated since brewing and frothing are separately done;

b. The process consumes too much time since coffee is made first before the froth.

c. The froth must be consumed since the air has been already pumped into the milk and any excessive amount of froth must be dumped.

d. The pot size is fixed to prevent it from easy adaptation to different sizes of coffee packs.

### SUMMARY OF THE INVENTION

The primary purpose of the present invention is to provide a coffee maker that includes a steam boiler adapted with a frothing unit containing a cylindrical cup sealed up for frothing while delivering steam to make coffee and froth at the same time for shortening the making process, saving time of making coffee, and providing better hygiene.

To achieve the purpose, the present invention includes a steam boiler, a brewing unit, and a frothing unit. Steam generated by the steam boiler is respectively led into both the brewing unit and the frothing unit. The brewing unit includes a chamber to accommodate a coffee pack. The present invention in characterized in that the frothing unit includes a cylindrical cup, a duct, and a suction tube; the bottom of the cylindrical cup is provided with an inlet tube and an outlet; the inlet tube introduces in the steam; the outlet is connected through the outer wall of the frothing unit; the duct connects the inlet tube and the outlet; the suction tube is connected to one side of the duct at where closer to the outlet; the suction tube containing an opening; and the opening is disposed inside the cylindrical cup.

When compared to the prior art, the present invention provides the following advantages:

a. The present invention shortens the coffee making process and allows brewing and frothing at the same time.

b. The present invention saves time in making coffee since it permits brewing and frothing at the same time.

c. In the present invention, no milk will be wasted because the amount of milk is determined by how much froth will be made.

d. The present invention provides better hygiene since the residual milk is kept in the cylindrical cup of the frothing unit.

e. The disk of the brewing unit is movably inserted into the chamber and may be replaced at any time according to the specification of the particular coffee pack used.

### BRIEF DESCRIPTION OF THE DRAWINGS

FIG. 1 is a perspective view of a preferred embodiment of the present invention.

FIG. 2 is an exploded view of the preferred embodiment of the present invention

FIG. 3 is a top view of the preferred embodiment of the present invention.

FIG. 4 is a sectional view showing a brewing unit in the preferred embodiment of the present invention of A-A taken from FIG. 3.

FIG. 5 is a sectional view showing a steam boiler and a frothing unit in the preferred embodiment of the present invention of B-B taken from FIG. 3.

FIG. 6 is a schematic view showing an operating status of the brewing unit of the preferred embodiment of the present invention.

FIG. 7 is a schematic view showing an operating status of the frothing unit of the preferred embodiment of the present invention.

FIG. 8 is a schematic view showing a disk of another preferred embodiment of the present invention.

### DETAILED DESCRIPTION OF THE PREFERRED EMBODIMENTS

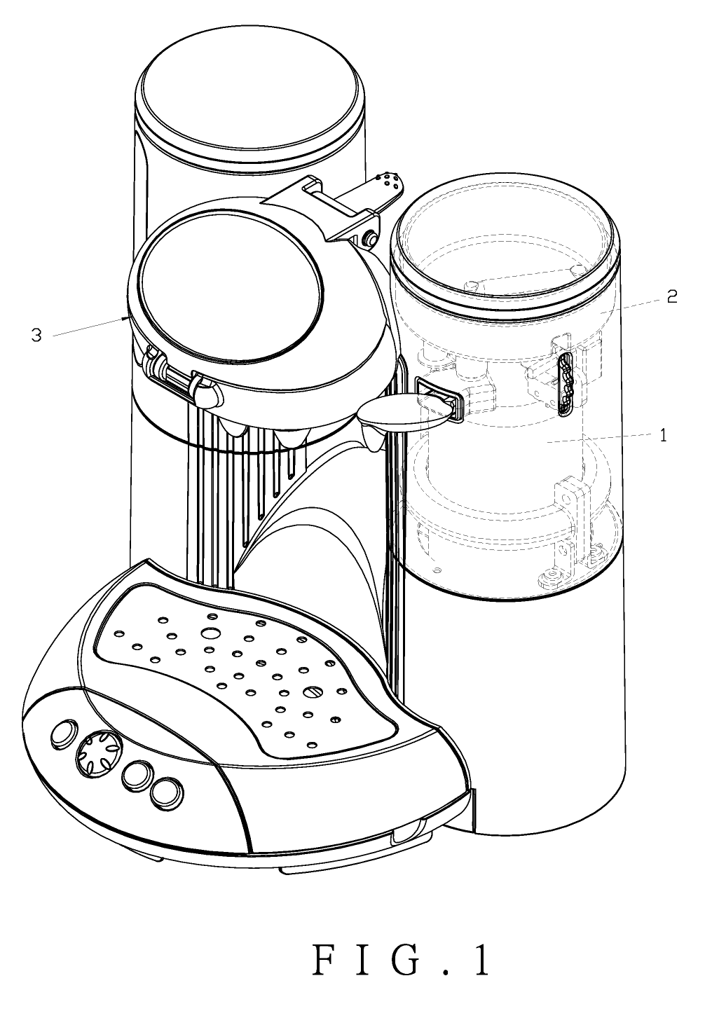

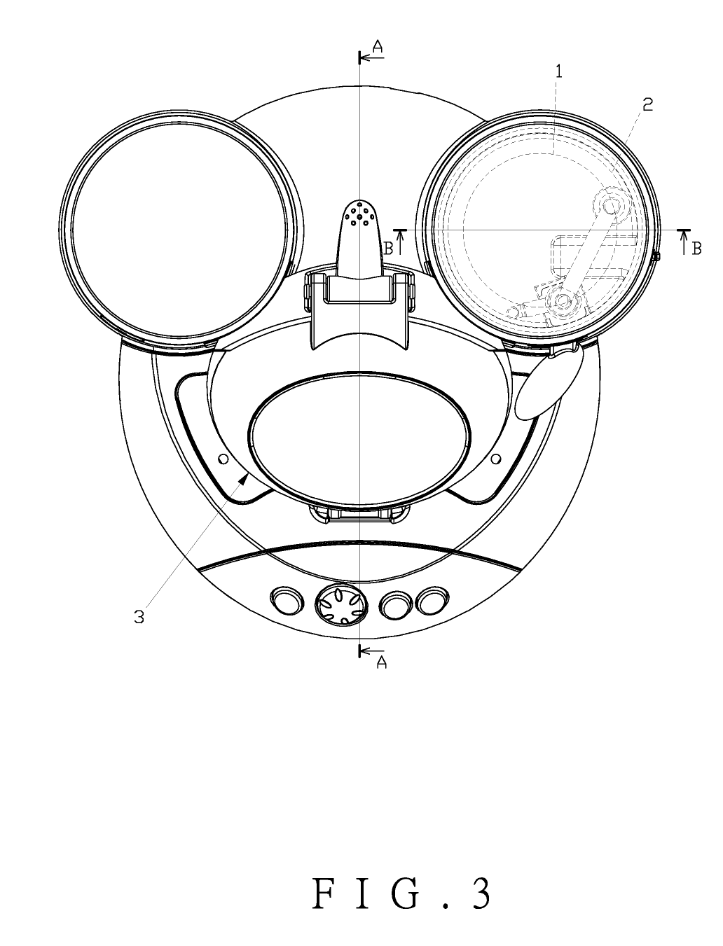

Referring to FIGS. 1 and 3, a preferred embodiment of the present invention comprises a steam boiler (1), a frothing unit (2), and a brewing unit (3).

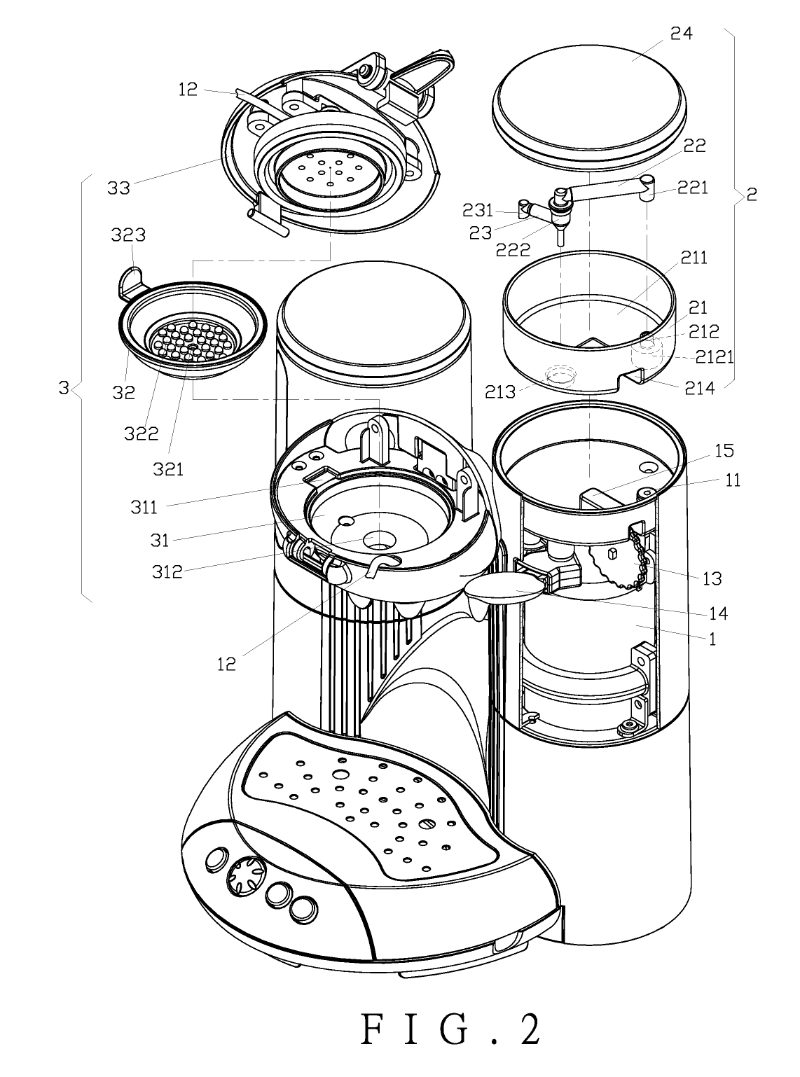

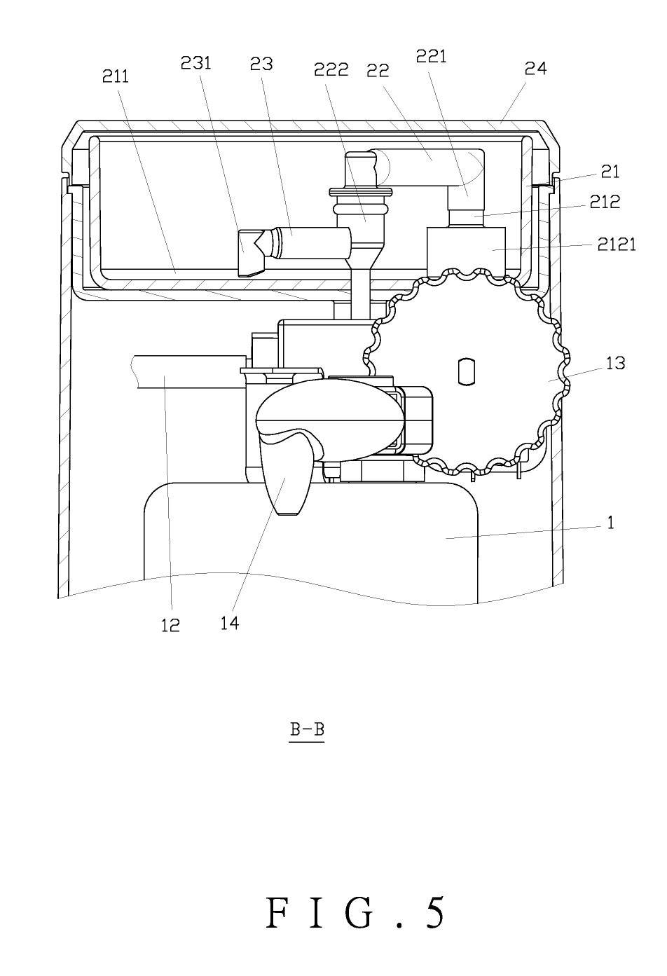

As illustrated in FIGS. 2 and 5, the steam boiler (1) comprises a steam nozzle (11), an extension duct (12), a knob (13), a froth duct (14), and a locating block (15). The steam nozzle (11) is provided on the top of the steam boiler (1). The extension duct (12) extends from the interior of the steam boiler (1) into the brewing unit (3). Both the knob (13) and the froth duct (14) are disposed externally at the top of the steam boiler (1). The knob (13) operates to regulate and control steam pressure of the steam nozzle (11) and the extension duct (12). The locating block (15) is disposed on top of the steam boiler (1). Accordingly, steam from the steam boiler (1) is partially and directly introduced from the steam nozzle (11) into the frothing unit (2) while the steam is partially introduced into the brewing unit (3) through the extension duct (12). The froth duct (14) delivers the forth made in the frothing unit (2).

As illustrated in FIGS. 2 and 5, the frothing unit (2) is disposed on top of the steam boiler (1) and comprises a cylindrical cup (21), a duct (22), and a suction tube (23). The cylindrical cup (21) includes a bottom (211) provided with an inlet tube (212), an outlet (213), and a locating groove (214). The bottom (211) of the cylindrical cup (21) is formed with an indention (2121) close to the inlet tube (212). The indention (212) corresponds in position to the steam nozzle (11) of the steam boiler (1) for streams to be introduced from the inlet tube (212). The outlet (213) connects the froth duct (14) to transport froth out of the frothing unit (2). The locating groove (214) corresponds in position to the locating block (15) so as to secure the cylindrical cup (21) in position. The duct (22) has an inlet end (221) and an outlet end (222) respectively connected to the inlet tube (212) and the outlet (213) of the cylindrical cup (21). The suction tube (23) connects to one side of the outlet end (222) of the duct (22) at where close to the outlet (213). The suction tube (23) has an opening (231) close to the bottom (211) of the cylindrical cup (21). The frothing unit (2) further comprises a lid (24) to cover up the cylindrical cup (21).

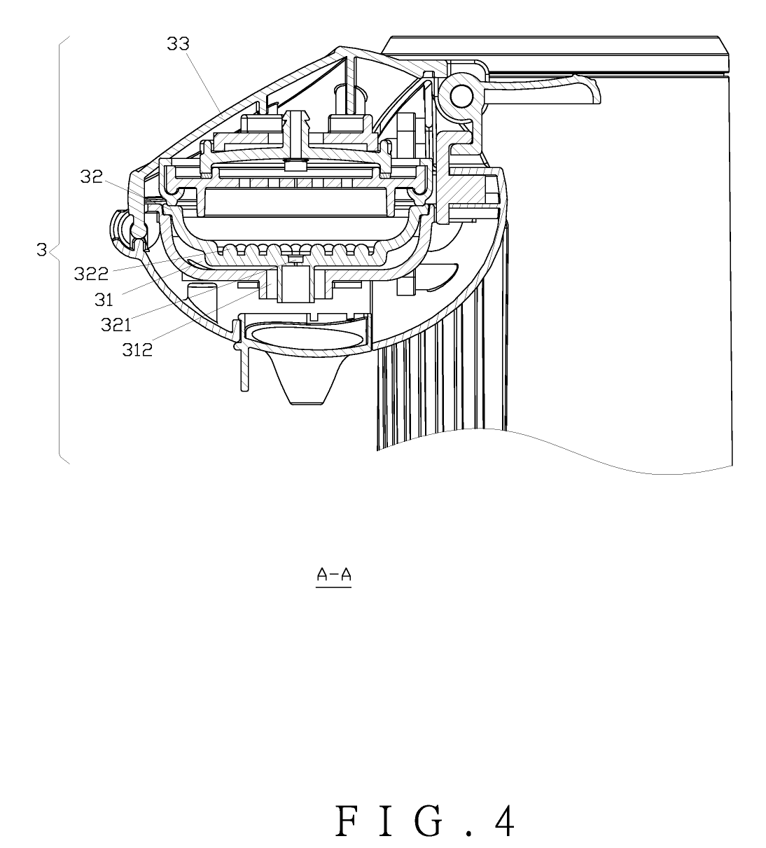

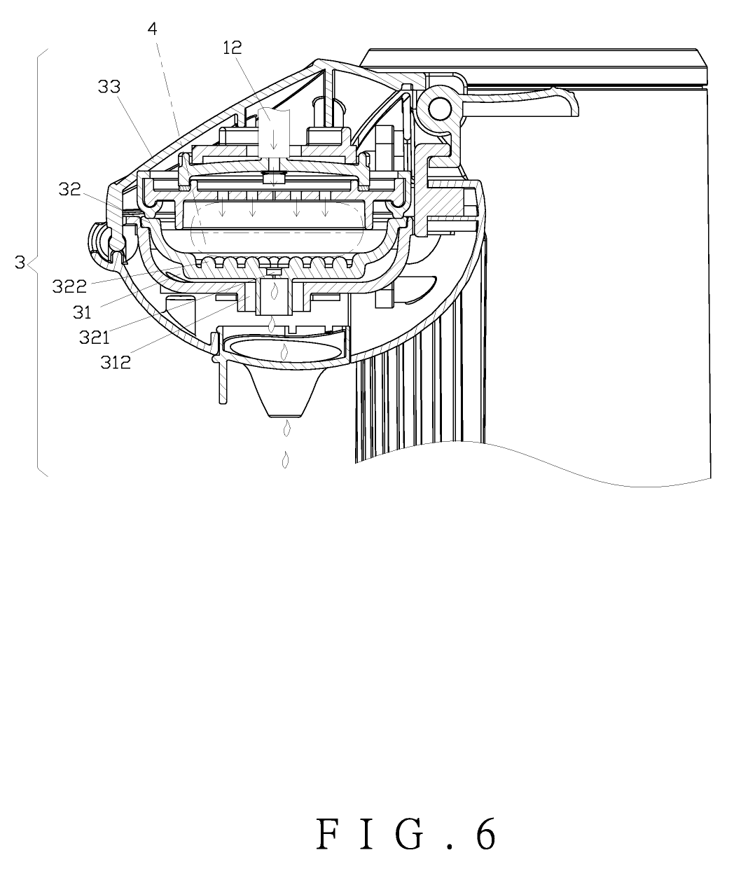

Now referring to FIGS. 2 and 4, the brewing unit (3) comprises chamber (31) therein. A disk (32) is provided in the chamber (31) to accommodate a coffee pack (4) as illustrated in FIG. 6. The disk (32) comprises a dipping hole (321), a plurality of nipples (322), and a handle (323). The brewing unit (3) is disposed with an insertion recess (311) to receive and secure the handle (323) in position. An outlet (312) is disposed in the chamber (31) corresponding in position to the dripping hole (321) to deliver the coffee. The brewing unit (3) further comprises a lifting lid (33) to cover up the chamber (31). The extension duct (12) extends into the lifting lid (33) in relation to the disk (32) in the chamber (31) and to the coffee pack (4) placed on the disk (32).

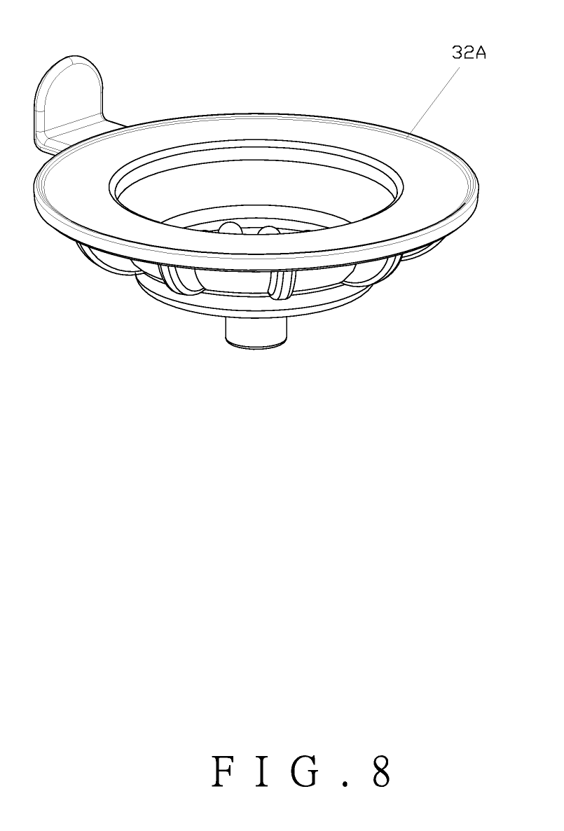

As illustrated in FIG. 6 for a schematic view showing the process of making coffee, steam from the steam boiler (1) is partially introduced into the coffee pack (4) in the brewing unit (3). The nipples (322) provided on the bottom of the disk (32) lift up the coffee pack (4) so as to facilitate the extraction of the coffee by steam. Extracted coffee liquid flows through gaps among the nipples (322) to the dripping hole (321) where to be delivered through the outlet (312). As the size of the coffee pack (4) may vary, the disk (32) is replaceable depending on the size of the coffee pack (4). As illustrated in FIG. 8, another disk (32A) is in the same dimension as that of the disk (32) but contains an internal space different from that of the disk (32). To make sure of both the disk (32A) and the disk (32) made in the same dimension, multiple ribs are provided to the disk (32A). Therefore, both disks (32, 32A) are interchangeable depending on the size of the coffee pack (4).

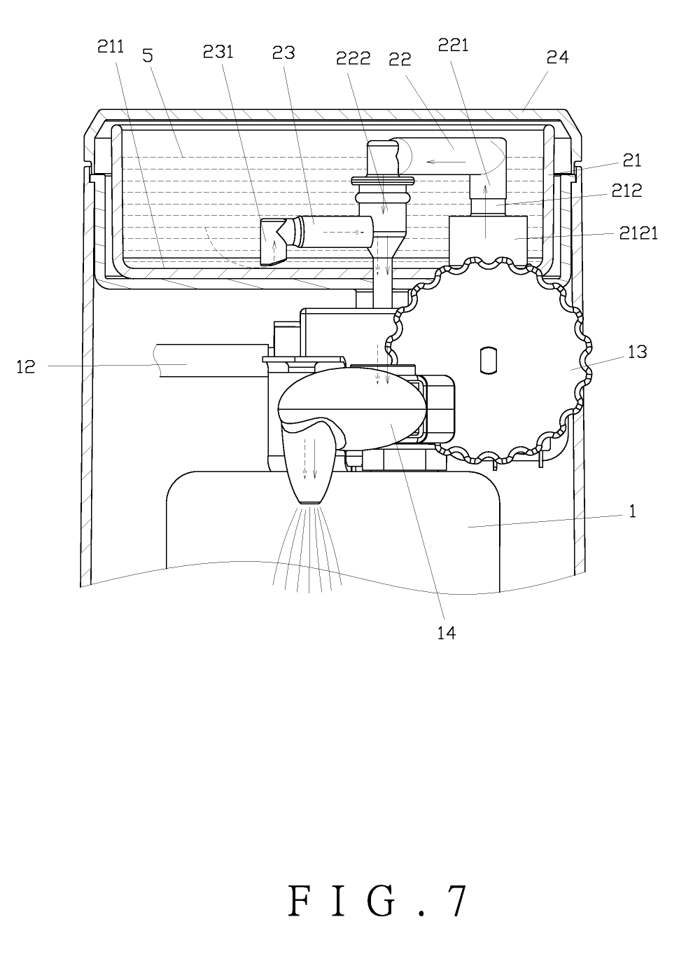

As illustrated in FIG. 7 for a schematic view of the frothing process of the present invention, steam supplied from the steam boiler (1) is directly introduced from the steam nozzle (11) into the inlet tube (21) of the cylindrical cup (21) of the frothing unit (2). Steam is then delivered to the forth duct (14) through the inlet end (221) and the outlet end (222) of the duct (22). The pressurized steam runs through the outlet end (222) drastically reduces side pressure on the wall of the froth duct (14) to create negative pressure for continuously sucking in milk (5) through the opening (231) of the suction tube (23) to enter into the outlet end (222) of the duct (22), where the milk (5) is well mixed with the steam in the froth duct (14) to make refined froth. The frothing process only consumes the amount of the milk (5) as needed. The remaining milk (5) is kept fresh for a longer time as it is contained in the cylindrical cup (21) covered up with the lid (24) of the frothing unit (2).

What is claimed is:

1. A coffee maker comprising a steam boiler, a frothing unit and a brewing unit; the steam boiler supplying steam; steam being respectively introduced into the frothing unit and the brewing unit; the brewing unit having a chamber to accommodate a coffee pack; and characterized by:
the frothing unit comprising a cylindrical cup, a duct, and a suction tube; the cylindrical cup having a bottom, an inlet tube and an outlet being disposed on the bottom of the cylindrical cup, the inlet tube introducing in steam, the duct connecting to the inlet tube and the outlet, the suction tube connecting to one side of the duct close to the outlet, the suction tube having an opening, and the opening being located inside the cylindrical cup.

2. The coffee maker as claimed in claim 1, wherein the brewing unit is provided with a disk having a dripping hole, the disk being disposed in the chamber to accommodate the coffee pack.

3. The coffee maker as claimed in claim 2, wherein the disk of the brewing unit is provided with a plurality of nipples.

4. The coffee maker as claimed in claim 2, wherein the disk of the brewing unit is inserted into the chamber.

5. The coffee maker as claimed in claim 4, wherein the disk is disposed with a handle and a recess is disposed in the brewing unit to receive and secure the handle in position.

6. The coffee maker as claimed in claim 1, wherein the bottom of the cylindrical up of the frothing unit is formed with an indention corresponding in position to the inlet tube.

7. The coffee maker as claimed in claim 1, wherein the opening of the suction tube of the frothing unit is located near the bottom of the cylindrical cup.

8. The coffee maker as claimed in claim 1, wherein the duct of the frothing unit has an inlet end and an outlet end, the inlet end connecting to the inlet tube of the cylindrical cup and the outlet end connecting to the outlet of the cylindrical cup.

9. The coffee maker as claimed in claim 1, wherein the frothing unit further comprises a lid to cover up the cylindrical cup.
